(19) United States
(12) Patent Application Publication
(10) Pub. No.: US 2009/0113039 A1
(43) Pub. Date: Apr. 30, 2009

(54) METHOD AND SYSTEM FOR CONTENT HANDLING

(75) Inventors: Raghvendra G. Savoor, Walnut Creek, CA (US); Zhi Li, San Ramon, CA (US); Jian Li, Sunnyvale, CA (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/924,393

(22) Filed: Oct. 25, 2007

(51) Int. Cl. G06F 15/173

(52) U.S. Cl. 709/224; 709/223; 709/225

(57) ABSTRACT

Methods and systems for content handling mapping are described. A client profile may be accessed. The client profile may include a general usage pattern of an access device. A current usage pattern of the access device may be accessed. The current usage pattern may be based on a plurality of interactions between the access device and a network server during a current time period. A determination may be made of whether the current usage pattern is in accordance with the client profile. A throttle instruction may be provided to a networked device to throttle at least one additional interaction of a plurality of additional interactions between the access device and the network server based on the determining. The networked device may be on an access network with the access device and the network server.

### FIELD

This application relates to a method and system for content processing, and more specifically to methods and systems for content handling.

### BACKGROUND

Access devices (e.g., set-top boxes) may be used to receive video content and other types of content from a network server. The received content may be provided for presentation to a user.

The user may select the content to be received from the network server by making a request. The request for content and other types of requests may be sent to the network server in the form of an instruction. The instruction may be received and processed by the network server. The network server may respond by providing the requested content and/or an instruction back to the access device.

### BRIEF DESCRIPTION OF DRAWINGS

Embodiments are illustrated by way of example and not limitation in the figures of the accompanying drawings, in which like reference characters indicate similar elements and in which:

FIG. 1 is block diagrams of an example content system according to an example embodiment;

FIG. 2 is block diagram of an example video content system according to an example embodiment;

FIG. 3 is a block diagram of an example system analyzer that may be deployed in the content system of FIGS. 1 and 2 according to an example embodiment;

FIG. 4 is a block diagram of an example access device that may be deployed in the content system of FIGS. 1 and 2 according to an example embodiment;

FIG. 5 is a block diagram of an example networked device that may be deployed in the content system of FIGS. 1 and 2 according to an example embodiment;

FIG. 6 is a flowchart illustrating a method for content handling in accordance with an example embodiment;

FIG. 7 is a flowchart illustrating a method for accessing a client profile in accordance with an example embodiment;

FIG. 8 is a flowchart illustrating a method for confirming throttling in accordance with an example embodiment;

FIGS. 9 and 10 are flowcharts illustrating a method for content handling in accordance with an example embodiment;

FIGS. 11 and 12 are flowcharts illustrating a method for confirming throttling in accordance with an example embodiment;

FIG. 13 is a flowchart illustrating a method for content handling in accordance with an example embodiment;

FIG. 14 is a block diagram of an IPTV system in which the content system of FIGS. 1 and 2 may be deployed in accordance with an example embodiment; and

FIG. 15 illustrates a diagrammatic representation of a machine in the example form of a computer system within which a set of instructions for causing the machine to perform any one or more of the methodologies discussed herein may be executed.

### DETAILED DESCRIPTION

Example methods and systems for handling content are described. In the following description, for purposes of explanation, numerous specific details are set forth in order to provide a thorough understanding of example embodiments. It will be evident, however, to one skilled in the art that the present invention may be practiced without these specific details.

In an example embodiment, a client profile may be accessed. The client profile may include a general usage pattern of an access device. A current usage pattern of the access device may be accessed. The current usage pattern may be based on a plurality of interactions between the access device and a network server during a current time period. A determination may be made of whether the current usage pattern is in accordance with the client profile. A throttle instruction may be provided to a networked device to throttle at least one additional interaction of a plurality of additional interactions between the access device and the network server based on the determining. The networked device may be on an access network with the access device and the network server.

In an example embodiment, a programming usage profile may be accessed. The programming usage profile may include a general usage pattern during an identified time period for a program. A plurality of interactions between a plurality of access devices and a network server may be monitored during a current time period associated with the program to identify a current usage pattern. A determination may be made as to whether the current usage pattern is in accordance with the programming usage profile. A throttle instruction may be provided to at least one networked device to throttle at least one additional interaction of a plurality of additional interactions between the plurality of access devices and the network server based on the determining. The at least one networked device may be on an access network with the plurality of access devices and the network server.

In an example embodiment, a client profile may be accessed. The client profile may include a general usage pattern of an access device. A plurality of interactions with a network server may be monitored during a current time period to identify a current usage pattern. A determination may be made as to whether the current usage pattern is in accordance with the client profile. At least one additional interaction of a plurality of additional interactions to the network server may be throttled.

In an example embodiment, a throttling instruction may be received. A source of the throttling instruction may be verified. A plurality of interactions between an access device and a network server may be throttled in accordance with the verifying of the source and the receiving of the throttling instruction.

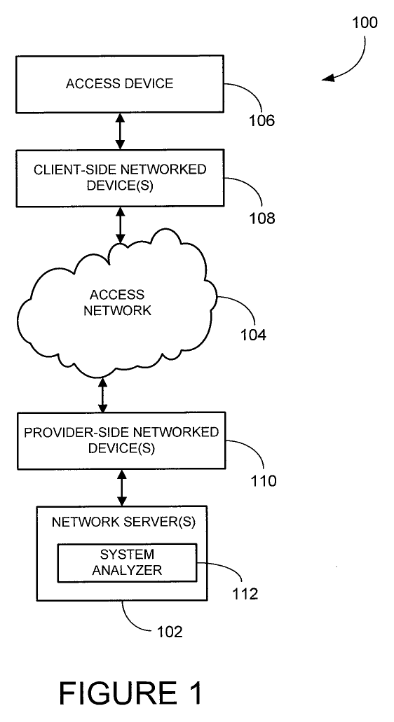

FIG. 1 illustrates an example content system 100. One or more network servers 102 may provide content to an access device 106 over an access network 104. The access device 106 may provide the content for presentation.

The network server 102 may include a number of applications associated with providing content to the access device 106 including a system analyzer 112. The system analyzer 112 may be used to monitor the interactions associated with one or more access devices 106 and, based on a determination, throttle one or more additional interactions.

The system analyzer 112 may enable a distributed and multi-layer framework for abnormality detection (e.g., an excessive number of interactions or a distributed denial of service (DDoS) attack). Throttling the additional interactions may then halt or reduce a DDoS attack initiated from the access device 106. The DDoS attack may have otherwise cause the network server 102 to run slowly and/or crash due to an excessive number of interactions (e.g., that may exceed the capacity of the network server 102).

The access network 104 used in the content system 100 may be a television distribution network, Global System for Mobile Communications (GSM) network, an Internet Protocol (IP) network, a Wireless Application Protocol (WAP) network, and/or a WiFi network. Other networks may also be used.

The access device 106 used in the content system 100 may be a set-top box (STB), a receiver card, a mobile telephone, a personal digital assistant (PDA), a gaming device, or a computing system; however other devices may also be used.

A client-side networked device 108 and/or a provider-side networked device 110 may be used to provide interactions between the network server 102 and the access device 106 and provide content from the network server 102 to the access device 106. The networked devices 108, 110 may include one or more switches, gateways, routers, firewalls, Digital Subscriber Line Access Multiplexers (DSLAMs), or the like.

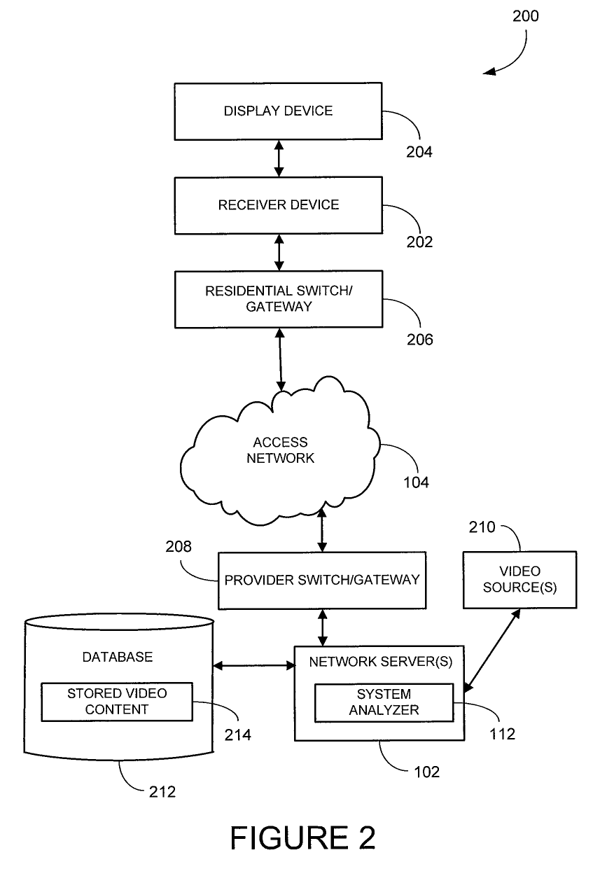

FIG. 2 illustrates an example video content system 200 in which the content system 100 (see FIG. 1) may be deployed. The one or more network servers 102 may provide video content and other types of content to the receiver device 202 over the access network 104. The receiver device 202 may provide the content to a display device 204 for presentation. The receiver device 202 may include the functionality of the access device 106 (see FIG. 1). The provided content may include video content, electronic program guide data, and other types of content.

The display device 204 may be a television monitor, a mobile telephone, a portable gaming device, a PDA, a computer monitor, and the like. Other types of display devices may also be used. The receiver device 202 and the display device 204 may be separate components or combined into a single device.

The content may be provided to the access device 106 through a residential switch/gateway 206 and/or a provider switch/gateway 208. The switches/gateways 206, 208 may enable distribution of the content in the video content system 200.

The network server 102 (e.g., an IPTV server) may provide content received from one or more video sources 210, content generated on the network server 102, and/or stored content 214 accessed from a database 212. The video sources 210 may include a television station, a broadcast network, a video server, or the like.

Content in the form of a video signal may be provided to the receiver device 202 for presentation on the display device 204. The video signal may be a sequence of images and one or more associated audio tracks. The video signal may be a high quality video stream (e.g., MPEG-4) that is transcoded (e.g., into H.264) for distribution. The video signal may include standard definition (SD) or high definition (HD) video signals in NTSC (National Television System Committee), PAL (Phase Alternation Line), SECAM (Systeme Electronique Couleur Avec Memoire), sequence of bitmaps or other signal formats that transport a sequence of images. The form of the video signal may be modified to enable implementations of various formats and resolutions. The video signal may provide a variety of content types including, without limitation, television programs, music, movies, and commercials.

The receiver device 202, the display device 204, and/or the residential switch/gateway 206 may include the functionality of the access device 106. The residential switch/gateway 206 may include the functionality of the client-side networked device 108. The provider switch/gateway 208 may include the functionality of the provider-side networked device 110.

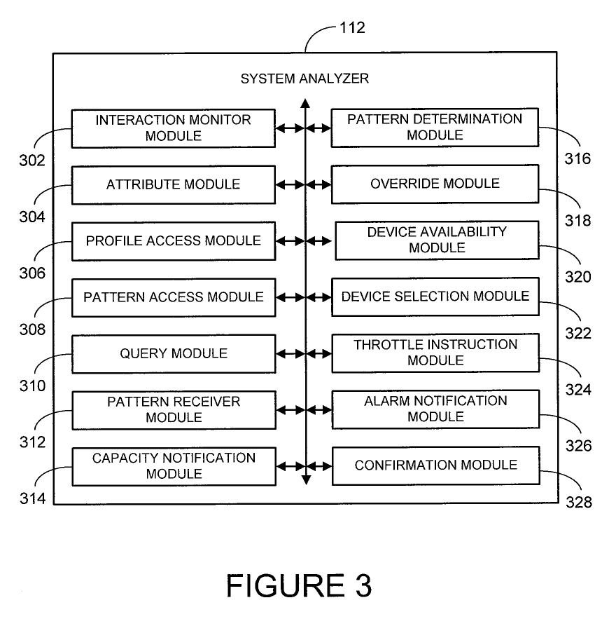

FIG. 3 illustrates an example system analyzer 112 that may be deployed in the content system 100, 200 (see FIGS. 1 and 2) and/or another system.

The example system analyzer 112 may include an interaction monitor module 302, an attribute module 304, a profile access module 306, a pattern access module 308, a query module 310, a pattern receiver module 312, a capacity notification module 314, a pattern determination module 316, an override module 318, a device availability module 320, a device selection module 322, a throttle instruction module 324, an alarm notification module 326, and/or a confirmation module 328. Other modules may also be used.

The interaction monitor module 302 monitors the interactions between the access device 106 and the network server 102 during a prior time period to create the client profile (e.g., as may be stored in the database 212 of FIG. 2) and/or during a current time period to identify a current usage pattern or a portion thereof. The interactions may include a service request, a request to schedule a DVR recording, a request for video on demand (VOD) content, a request for data, a channel change request, a group rights request (e.g., parental control), a request for an electronic program guide (EPG), a search request, a download request, and the like.

The attribute module 304 adds a subscriber attribute to the client profile. The subscriber attributes may include at a client subscription or rights, a logical identifier, a physical identifier (e.g., an IP address or MAC address), a physical location correlation, or the like.

In an example embodiment, the physical location correlation may be a physical path that an interaction (e.g., a service request message) travels along from the access device 106 via a Residential Gateway (RG) to a DSLAM port. By way of an example, if the access device 106 has a virus or is otherwise compromised client device and starts a DDoS attack, the access device 106 may be identified by checking the physical path which the attacking interactions have come from as the path may not be in accordance with the setup of the system 100.

The profile access module 306 accesses a client profile and/or a programming usage profile (e.g., from the database 212). The client profile may include a general usage pattern of the access device 106. The programming usage profile includes a general usage pattern for a program during an identified time period.

The pattern access module 308 accesses a current usage pattern of the access device 106. The current usage pattern may be based on interactions between the access device 106 and the network server 102 during a current time period.

The query module 310 sends a pattern query to at least one additional server on the access network 104. The pattern receiver module 312 receives current user pattern or a portion thereof from the access device 106 and/or the additional server.

The capacity notification module 314 receives a capacity notification associated with exceeding normal capacity of the network server 102. The pattern determination module 316 determines whether the current usage pattern is in accordance with the client profile. The current usage pattern may be in accordance with the client profile when, by way of example, the number and/or type of interactions are in compliance with and/or within a range of an expected number and/or type of interactions. The operations performed by the pattern determination module 316 may be initiated based on the receiving of the capacity notification or otherwise initiated.

The override module 318 accesses an override setting (e.g., based on a known condition such as Super Bowl) for the access network 104. The override setting may be stored in the database 212 (see FIG. 2) or otherwise stored. The device availability module 320 determines available networked devices 108, 110 on the access network 104 on a network path between the access device 106 and the network server 102.

The device selection module 322 selects the networked device 108, 110 from the available networked devices 108, 110 in accordance with a selection criterion. The selection criterion may include proximity of the available networked devices 108, 110 on the network path to the access device 106, a non-virused networked device 108, 110, a controllable networked device 108, 110, or combinations thereof.

The throttle instruction module 324 provides a throttle instruction to the networked device 108, 110 and/or an additional network device 108, 110 to throttle one or more additional interactions between the access device 106 and the network server 102 based on the determination performed by the pattern determination module 316. The throttled interactions may be from the access device 106 to the network server 102, from the network server 102 to the access device 106, from the access device 106 to another server on the access network 104, or the like. The providing of the throttle instruction may be in accordance with the override setting. The throttle instruction may be provided to the networked device 108, 110 to throttle one or more interactions of a single interaction type or of multiple interaction types. The alarm notification module 326 provides an alarm notification regarding the throttle instruction.

The confirmation module 328 provides a confirmation instruction to the access device 106 and/or an additional device (e.g., a mobile telephone) associated with a user of the access device 106, receives a confirmation response to the confirmation request from the access device 106, and/or provides a restore instruction to the access device 106 in accordance with the receiving of the response. The confirmation instruction may include an image-based text conformation instruction.

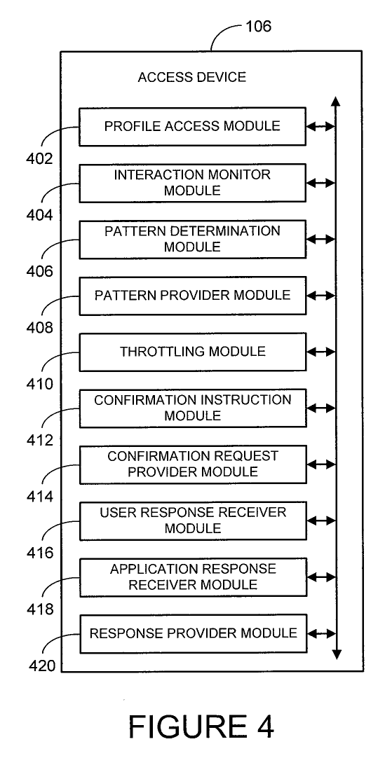

FIG. 4 illustrates an example access device 106 that may be deployed in the content system 100 (see FIG. 1) and/or another system.

The access device 106 may include a profile access module 402, an interaction monitor module 404, a pattern determination module 406, a pattern provider module 408, a throttling module 410, a confirmation instruction module 412, a confirmation request provider module 414, a user response receiver module 416, an application response receiver module 418, and/or a response provider module 420. Other modules may also be used.

The profile access module 402 accesses a client profile. The client profile may include a general usage pattern of the access device 106. The client profile may be received from the network server 102, accessed from storage on the access device 106, or otherwise accessed.

The interaction monitor module 404 monitors interactions with the network server 102 during a current time period to identify a current usage pattern. The pattern determination module 406 determines whether the current usage pattern is in accordance with the client profile.

The pattern provider module 408 provides the current usage pattern to the system analyzer 112. The throttling module 410 throttles one or more additional interactions to the network server 102.

The confirmation instruction module 412 receives a confirmation instruction from the system analyzer 112. The confirmation request provider module 414 provides a confirmation request for presentation and/or to an application (e.g., anti-virus software) running on the access device 106. The user response receiver module 416 receives a user response to the confirmation request. The application response receiver module 418 receives an application response to the confirmation request. The response provider module 420 provides a confirmation response to the system analyzer 112.

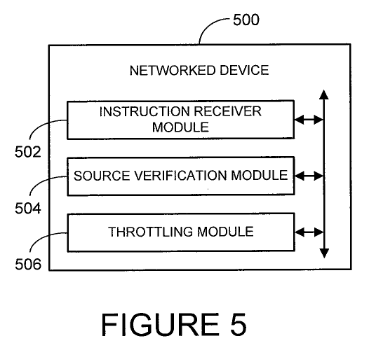

FIG. 5 illustrates an example networked device 500 that may be deployed in the content system 100 as the client-side networked device 108 and/or the provider-side networked device 110, in the content system 200 as the residential switch/gateway 206, the provider switch/gateway 208, and/or otherwise deployed in another system.

The networked device 500 may include an instruction receiver module 502, a source verification module 504, and/or a throttling module 506. Other modules may also be used.

The instruction receiver module 502 receives a throttling instruction. The source verification module 504 verifies a source (e.g., the system analyzer 112) of the throttling instruction. The throttling module 506 throttles interactions between the access device 106 and the network server 102 in accordance with the verifying of the source and the receiving of the throttling instruction.

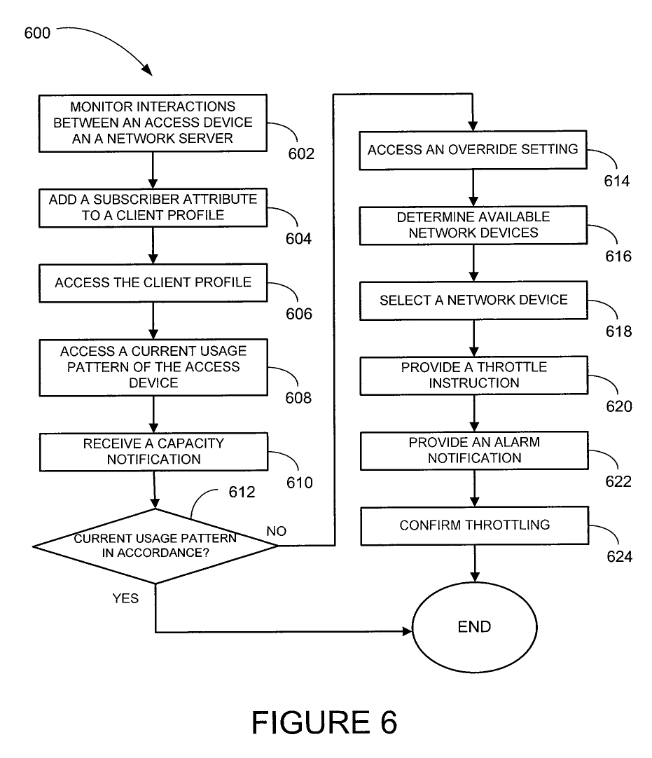

FIG. 6 illustrates a method 600 for content handling according to an example embodiment. The method 600 may be performed by the system analyzer 112 (see FIGS. 1 and 2) of the content systems 100, 200 or otherwise performed.

At block 602, the interactions between the access device 106 and the network server 102 may be monitored during a prior time period to create a general usage pattern of a client profile. The interactions may include a service request, a request to schedule a DVR recording, a request for video on demand (VOD) content, a request for data, a channel change request, a group rights request (e.g., parental control), a request for an electronic program guide (EPG), a search request, a download request, or the like.

The general usage pattern may be created by use of one or more of following:
a measured number of the interactions between the access device 106 and the network server 102 during the prior time period,
a measured distribution of the interactions between the access device 106 and the network server 102 during the prior time period,
a measured number of interactions between a local geographic area and the network server 102 during the prior time period,
a measured distribution of the interactions between the access device 106 and the network server 102 during the prior time period,
a historical activity trending number of the interactions between the access device 106 and the network server 102 for an expected time period,
a historical activity trending distribution of the interactions between the access device 106 and the network server 102 for the expected time period,
a forecasted activity number of the interactions between the access device 106 and the network server 102 for a future time period (e.g., a special event), and
a forecasted activity trending distribution of the interactions between the access device 106 and the network server 102 for the future time period.
   The general usage pattern may also be based on interactions in other ways.

The client profile including the general usage pattern may be stored on the network server 102 and/or in the database 212. The client profile may be unique for a particular access device 106. The client profile may be weighted based on one or more of the previously described factors and/or other factors.

One or more subscriber attributes may be added to a client profile at block 604. The subscriber attribute may be a client subscription or rights, a logical identifier, a physical identifier (e.g., an IP address or MAC address), a physical location correlation, and the like. The client profile is then accessed at block 606.

A current usage pattern of the access device 106 may be accessed at block 608. The current usage pattern may be based on interactions between the access device 106 and the network server 102 during a current time period. An example embodiment of access the current usage pattern is described in greater detail below.

A capacity notification associated with exceeding normal capacity of the network server 102 may be received at block 610. The capacity notification may be received from another application operating on the network server 102 or otherwise received to indicate that an excessive amount of instructions of or more types are being received by the network server.

At decision block 612, a determination may be made as to whether the current usage pattern is in accordance with the client profile. The current usage pattern may be in accordance with the client profile when, by way of example, the number and/or type of interactions are in compliance with and/or within a range of an expected number and/or type of interactions. If a determination is made that the current user pattern is in accordance with the client profile, the method 600 may terminate. If a determination is made at decision block 612 that the current user pattern is not in accordance with the user profile, the method 600 may proceed to block 614. In an example embodiment, the determination performed during the operations at decision block 612 may be initiated based on the receiving of the capacity notification at block 610.

An override setting may be accessed for the access network 104 at block 614. The override setting may be set by an operator based on a known condition for the access network 104. For example, there may be more interactions and/or different types of interactions during the Super Bowl in contrast with a typical Sunday evening broadcast. The operator may thereby indicate to the system analyzer 112 not to throttle excessive instructions while the override setting is in effect.

At block 616, a determination of available networked devices 500 on the access network 104 on a network path between the access device 106 and the network server 102 may be determined. Based on the determination, one or more networked devices 500 may be selected from of available networked devices 500 in accordance with a selection criterion at block 618. The selection criterion may include, by way of example, proximity of the available networked devices 500 on the network path to the access device 106, a non-virused networked device 500, and/or a controllable networked device 500.

In an example embodiment, the selection of the networked devices 500 may be to perform a controlled examination if case of a doubt of an excessive number of interactions (e.g., service requests) and/or being under a DDoS attack.

At block 620, a throttle instruction is provided to the networked device 500 and/or the additional networked device 500 to throttle one or more additional interactions between the access device 106 and the network server 102 (e.g., when the current usage pattern is not in accordance at decision block 612). The throttled interactions may be from the access device 106 to the network server 102, from the network server 102 to the access device 106, from the access device 106 to another server, or the like.

The throttle instruction provided to the networked device 500 may be to throttle one or more interactions of a single interaction type or of multiple interaction types (e.g., all interactions).

By providing the throttle instruction to the networked device 500 and/or an additional networked device 500, the throttling functions may be pushed from a centralized server firewall much further out to different levels in the system 100 (e.g., at a DSLAM port and/or a service access point (SAP)).

An alarm notification may be provided regarding the throttle instruction at block 622. The alarm notification may alert the operator of the content system 100, 200 and/or another that the networked device 500 is throttling instructions associated with a particular access device 106. The alarm notification may be provided via e-mail, a text message, or otherwise provided.

A confirmation of throttling may be performed at block 624. An example embodiment of a method for confirmation of throttling is described in greater detail below.

In an example embodiment, multiple access devices 106 may be accessed (e.g., in a geographic area) to check existence of a similarity in a behavior pattern that is related to geographic proximity. The accessing of the multiple access devices 106 may provide helpful troubleshooting information.

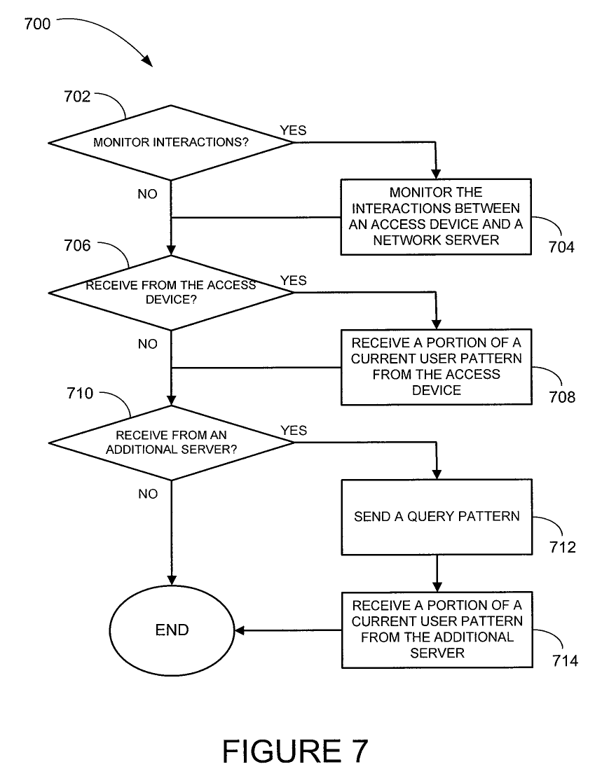

FIG. 7 illustrates a method 700 for accessing a client profile according to an example embodiment. The method 700 may be performed at the block 606 (see FIG. 6) or otherwise performed.

A determination may be made at decision block 702 whether to access a current user pattern or a portion thereof by monitoring the interactions. If a determination is made to monitor, the interactions between the access device 106 and the network server 102 may be monitored during a current time period to identify the current usage pattern or a portion thereof. If a determination is made not to monitor at decision block 702, or upon completion of the operations at block 704, the method 700 may proceed to decision block 706.

At decision block 706, a determination may be made whether to access a current user pattern or a portion thereof by receiving the current usage pattern from the access device 106. If a determination is made to receive, the current usage pattern may be received from the access device 106 at block 708. If a determination is made not to receive at decision block 706 or upon completion of the operations at block 708, the method 700 may proceed to decision block 710.

A determination may be made at decision block 710 whether to access a current user pattern or a portion thereof by receiving the current usage pattern from one or more additional servers (e.g., on the access network 104). If a determination is made to receive, a pattern query may be sent to additional servers on the access network 104 and the current usage pattern or a portion thereof may be received from one or more additional servers. If a determination is made not to receive at decision block 710 or upon completion of the operations at block 714, the method 700 may terminate.

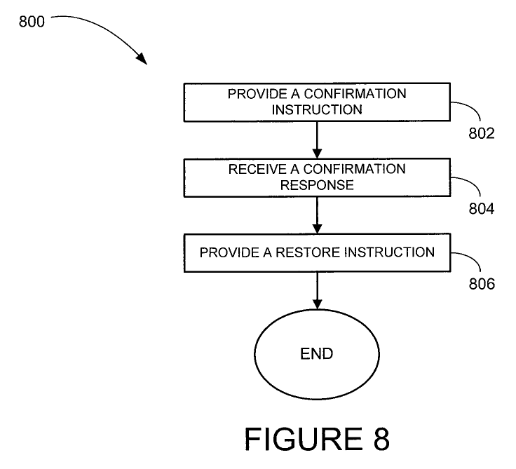

FIG. 8 illustrates a method 800 for confirming throttling according to an example embodiment. The method 800 may be performed at the block 624 (see FIG. 6) or otherwise performed.

A confirmation instruction is provided at block 802. The confirmation instruction may be provided to the access device 106 and/or a different device associated with a user of the access device 106. The confirmation instruction may include an image-based text conformation instruction (e.g., requesting that a user type the text contained in an image), a user log in, or the like. Other types of conformation instructions may also be used.

A confirmation response to the confirmation request may be received from the access device 106 and/or the different device at block 804. At block 806, a restore instruction may be provided to the access device 106 in accordance with the receiving of the response.

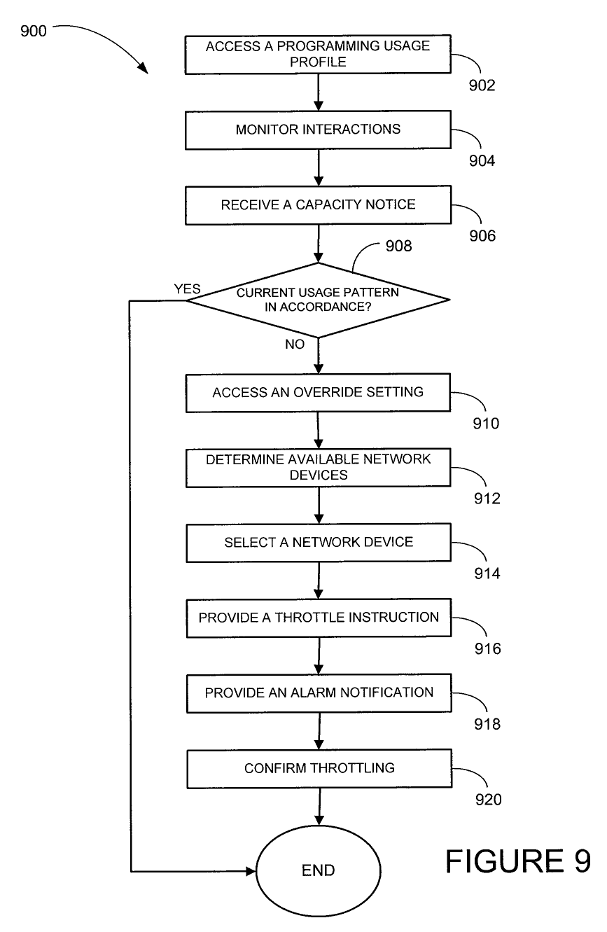

FIG. 9 illustrates a method 900 for content handling according to an example embodiment. The method 900 may be performed by the system analyzer 112 (see FIGS. 1 and 2) of the content system 100, 200 or otherwise performed.

A programming usage profile is accessed at block 902. The programming usage profile may include a general usage pattern during an identified time period for a program.

At block 904, interactions associated with a program between multiple access devices 106 and the network server 102 may be monitored during a current time period to identify a current usage pattern. A capacity notification associated with exceeding normal capacity of the network server 102 may be received at block 906.

At decision block 908, a determination may be made as to whether the current usage pattern is in accordance with the general usage pattern. The current usage pattern may be in accordance with the client profile when, by way of example, the number and/or type of interactions are in compliance with and/or within a range of an expected number and/or type of interactions. If a determination is made that the current user pattern is in accordance with the general usage pattern, the method 900 may terminate. If a determination is made at decision block 908 that the current usage pattern is not in accordance with the general usage pattern, the method 900 may proceed to block 920. In an example embodiment, the determination performed during the operations at decision block 908 may be initiated based on the receiving of the capacity notification at block 906.

An override setting may be accessed for the access network 104 at block 910. The override setting may be set by an operator based on a known condition for the access network 104. For example, there may be more interactions and/or different types of interactions during the Super Bowl in contrast with a typical Sunday evening broadcast.

At decision block 912, a determination of available networked devices 500 on the access network 104 on a network path between the access device 106 and the network server 102 may be determined. Based on the determination, one or more networked devices 500 may be selected from of available networked devices 500 in accordance with a selection criterion at block 914. The selection criterion may include, by way of example, proximity of the available networked devices 500 on the network path to the access device 106, a non-virused networked device 500, and/or a controllable networked device 500.

At block 916, a throttle instruction is provided to the networked device 500 and/or the additional networked device 500 to throttle one or more additional interactions between the access device 106 and the network server 102 (e.g., when the current usage pattern is not in accordance at decision block 908). The throttled interactions may be from the access device 106 to the network server 102, from the network server 102 to the access device 106, from the access device 106 to another server, or the like.

An alarm notification may be provided regarding the throttle instruction at block 918. The alarm notification may alert the operator of the content system 100, 200 and/or another that the networked device 500 is throttling instructions associated with a particular access device 106. The alarm notification may be provided via e-mail, a text message, or otherwise provided.

A confirmation of throttling may be performed at block 920. The method 700 and/or the method 800 (see FIGS. 7 and 8) may be performed at block 920.

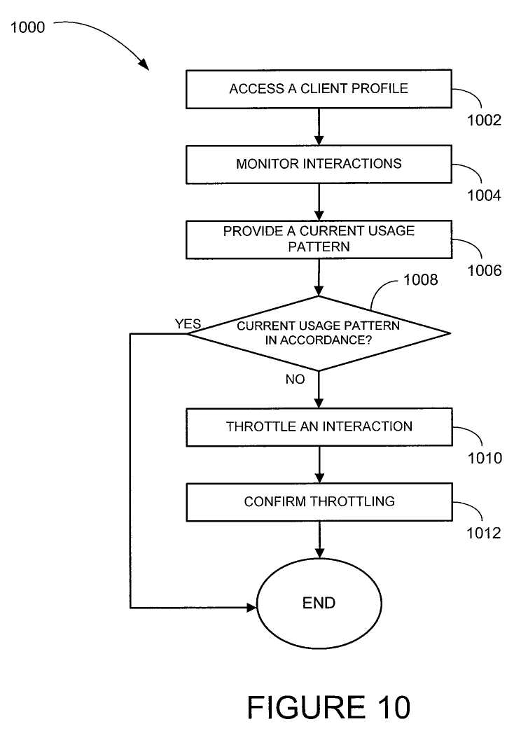

FIG. 10 illustrates a method 1000 for content handling according to an example embodiment. The method 1000 may be performed by the access device 106 (see FIGS. 1 and 2) of the content system 100, 200 or otherwise performed.

A client profile may be accessed at block 1002. The client profile may include a general usage pattern of the access device 106. The client profile may be received from the network server.

At block 1004, interactions with the network server 102 are monitored during a current time period to identify a current usage pattern. The current usage pattern may be provided to the system analyzer 112 at block 1006.

At decision block 1008, a determination may be made as to whether the current usage pattern is in accordance with the client profile. The current usage pattern may be in accordance with the client profile when, by way of example, the number and/or type of interactions are in compliance with and/or within a range of an expected number and/or type of interactions. If a determination is made that the current usage pattern is not in accordance with the client profile, one or more additional interactions may be throttled to the network server 102 at block 1010. Throttling may include, by way of example, dropping or delaying requests, closing a port on the access device 106, and the like. The throttling may be confirmed at block 1012. If a determination is made that the current usage pattern is in accordance with the client profile or upon completion of the operations at block 1012, the method 1000 may terminate.

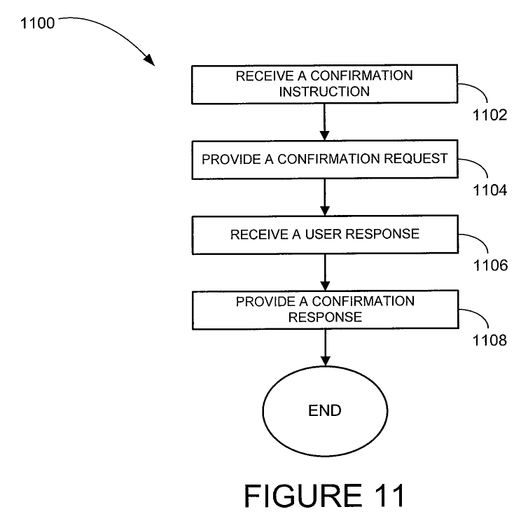

FIG. 11 illustrates a method 1100 for confirming throttling according to an example embodiment. The method 1100 may be performed at the block 1012 (see FIG. 10) or otherwise performed.

At block 1102, a confirmation instruction may be received from the system analyzer 112. A confirmation request is provided for presentation at block 1104. The confirmation request may be provided for presentation in accordance with the receiving of the confirmation instruction

A user response is received to the confirmation request at block 1106. A confirmation response may be provided to the networked device 500 at block 1108. The confirmation response may be provided to the system analyzer 112 in accordance with the receiving of the user response.

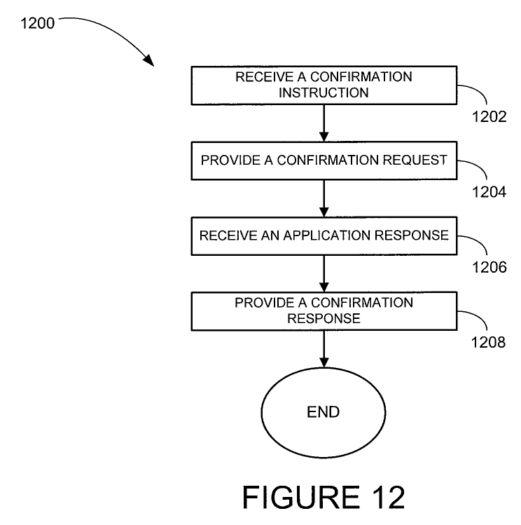

FIG. 12 illustrates a method 1200 for confirming throttling according to an example embodiment. The method 1200 may be performed at the block 1012 (see FIG. 10) or otherwise performed.

A confirmation instruction is received from the system analyzer 112 at block 1202. At block 1204, a confirmation request is provided to an application (e.g., anti-virus software) running on the access device 106. An application response is received to the confirmation request at block 1206. A confirmation response is provided to the system analyzer 112 at block 1208.

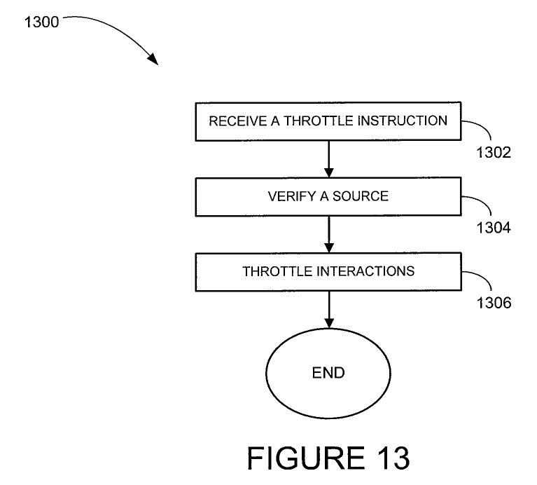

FIG. 13 illustrates a method 1300 for handling content according to an example embodiment. The method 1300 may be performed by the networked device 500 (see FIG. 5) as deployed in the content systems 100, 200 or otherwise performed.

A throttling instruction is received at block 1302. A source of the throttling instruction is verified at block 1304. At block 1306, interactions between the access device 106 and the network server 102 are throttled in accordance with the verifying of the source and the receiving of the throttling instruction.

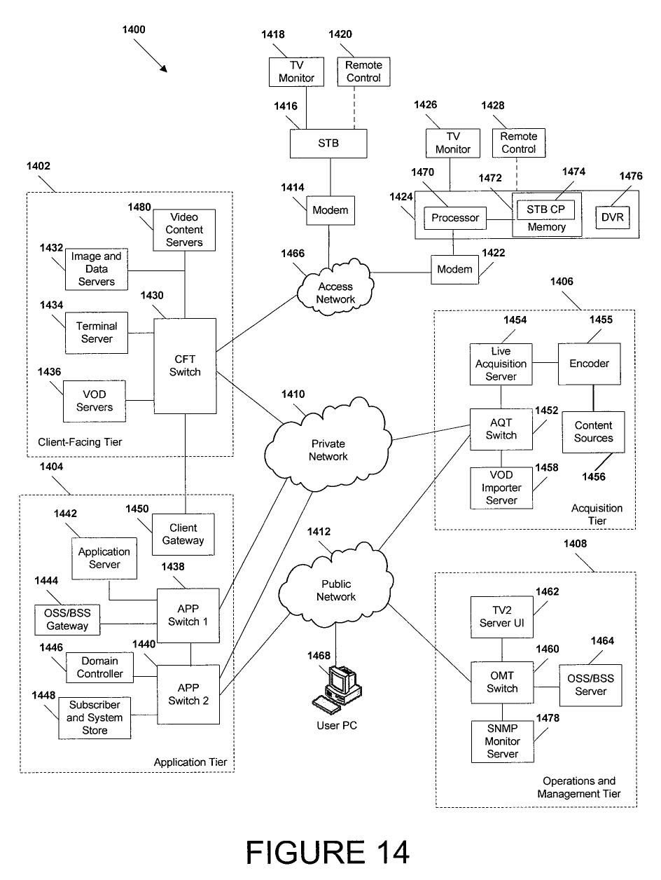

FIG. 14 illustrates an example embodiment of an Internet Protocol Television (IPTV) system 1400 in which the content system 100 may be deployed. However, the content system 100 may be deployed in other types of IPTV and non-IPTV video systems.

The system 1400 as illustrated may include a client facing tier 1402, an application tier 1404, an acquisition tier 1406, and an operations and management tier 1408. Some tiers 1402, 1404, 1406, 1408 may be coupled to a private network 1410; to a public network 1412, such as the Internet; or to both the private network 1410 and the public network 1412. For example, the client-facing tier 1402 may be coupled to the private network 1410. Further, the application tier 1404 may be coupled to the private network 1410 and to the public network 1412. The acquisition tier 1406 may also be coupled to the private network 1410 and to the public network 1412. Additionally, the operations and management tier 1408 may be coupled to the public network 1412.

As illustrated in FIG. 14, some of the various tiers 1402, 1404, 1406, 1408 may communicate with each other via the private network 1410 and the public network 1412. For instance, the client-facing tier 1402 may communicate with the application tier 1404 and the acquisition tier 1406 via the private network 1410. The application tier 1404 may also communicate with the acquisition tier 1406 via the private network 1410. Further, the application tier 1404 may communicate with the acquisition tier 1406 and the operations and management tier 1408 via the public network 1412. Moreover, the acquisition tier 1406 may communicate with the operations and management tier 1408 via the public network 1412. In a particular As illustrated in FIG. 14, the client-facing tier 1402 may communicate with user equipment via a private access network 1466 (e.g., the access network 104 of FIGS. 1 and 2), such as an IPTV access network. In an illustrative embodiment, modems, such as a first modem 1414 and a second modem 1422 may be coupled to the private access network 1466. The client-facing tier 1402 may communicate with a first representative set-top box device 1416 via the first modem 1414 and with a second representative set-top box device 1424 via the second modem 1422. The client-facing tier 1402 may communicate with a large number of set-top boxes, such as the representative set-top boxes 1416, 1424, (e.g., the access device 106 of FIG. 1 and/or the receiver device 202 of FIG. 2) over a wide geographic area, such as a regional area, a metropolitan area, a viewing area, a designated market area or any other suitable geographic area, market area, or subscriber or customer group that may be supported by networking the client-facing tier 1402 to numerous set-top box devices. In an illustrative embodiment, the client-facing tier, or any portion thereof, may be included at a video head-end office.

In a particular embodiment, the client-facing tier 1402 may be coupled to the modems 1414, 1422 via fiber optic cables. Alternatively, the modems 1414 and 1422 may be digital subscriber line (DSL) modems that are coupled to one or more network nodes via twisted pairs, and the client-facing tier 1402 may be coupled to the network nodes via fiber-optic cables. Each set-top box device 1416, 1424 may process data received via the private access network 1466, via an IPTV software platform, such as Microsoft® TV IPTV Edition. In another embodiment, representative set-top boxes 1416, 1424 may receive data from private access network 1466 through RF and other cable and/or satellite based networks.

Additionally, the first set-top box device 1416 may be coupled to a first external display device, such as a first television monitor 1418, and the second set-top box device 1424 may be coupled to a second external display device, such as a second television monitor 1426. Moreover, the first set-top box device 1416 may communicate with a first remote control 1420, and the second set-top box device may communicate with a second remote control 1428.

In an example, non-limiting embodiment, one or more of set-top box devices 1416, 1424 may receive video content, which may include video and audio portions, from the client-facing tier 1402 via the private access network 1466. The set-top boxes 1416, 1424 may transmit the video content to an external display device, such as the television monitors 1418, 1426. Further, some of the set-top box devices 1416, 1424 may include a STB processor, such as STB processor 1470, and a STB memory device, such as STB memory 1472, which is accessible to the STB processor 1470. In one embodiment, a computer program, such as the STB computer program 1474, may be embedded within the STB memory device 1472. Some set-top box devices 1416, 1424 may also include a video content storage module, such as a digital video recorder (DVR) 1476. In a particular embodiment, the set-top box devices 1416, 1424 may communicate commands received from the remote control devices 1420, 1428 to the client-facing tier 1402 via the private access network 1466.

In an illustrative embodiment, the client-facing tier 1402 may include a client-facing tier (CFT) switch 1430 that manages communication between the client-facing tier 1402 and the private access network 1466 and between the client-facing tier 1402 and the private network 1410. As shown, the CFT switch 1430 is coupled to one or more image and data servers 1432 that store still images associated with programs of various IPTV channels. The image and data servers 1432 may also store data related to various channels, e.g., types of data related to the channels and to programs or video content displayed via the channels. In an illustrative embodiment, the image and data servers 1432 may be a cluster of servers, some of which may store still images, channel and program-related data, or any combination thereof. The CFT switch 1430 may also be coupled to a terminal server 1434 that provides terminal devices with a connection point to the private network 1410. In a particular embodiment, the CFT switch 1430 may also be coupled to one or more video-on-demand (VOD) servers 1436 that store or provide VOD content imported by the IPTV system 1400. In an illustrative, non-limiting embodiment, the VOD content servers 1480 may include one or more unicast servers.

The client-facing tier 1402 may also include one or more video content servers 1480 that transmit video content requested by viewers via their set-top boxes 1416, 1424. In an illustrative, non-limiting embodiment, the video content servers 1480 may include one or more multicast servers.

As illustrated in FIG. 14, the application tier 1404 may communicate with both the private network 1410 and the public network 1412. The application tier 1404 may include a first application tier (APP) switch 1438 and a second APP switch 1440. In a particular embodiment, the first APP switch 1438 may be coupled to the second APP switch 1440. The first APP switch 1438 may be coupled to an application server 1442 and to an OSS/BSS gateway 1444. In a particular embodiment, the application server 1442 may provide applications to the set-top box devices 1416, 1424 via the private access network 1466, which enable the set-top box devices 1416, 1424 to provide functions, such as display, messaging, processing of IPTV data and VOD material, etc. In a particular embodiment, the OSS/BSS gateway 1444 includes operation systems and support (OSS) data, as well as billing systems and support (BSS) data. In one embodiment, the OSS/BSS gateway may provide or restrict access to an OSS/BSS server 1464 that stores operations and billing systems data.

Further, the second APP switch 1440 may be coupled to a domain controller 1446 that provides web access, for example, to users via the public network 1412. For example, the domain controller 1446 may provide remote web access to IPTV account information via the public network 1412, which users may access using their personal computers 1468. The second APP switch 1440 may be coupled to a subscriber and system store 1448 that includes account information, such as account information that is associated with users who access the system 1400 via the private network 1410 or the public network 1412. In a particular embodiment, the application tier 1404 may also include a client gateway 1450 that communicates data directly with the client-facing tier 1402. In this embodiment, the client gateway 1450 may be coupled directly to the CFT switch 1430. The client gateway 1450 may provide user access to the private network 1410 and the tiers coupled thereto.

In a particular embodiment, the set-top box devices 1416, 1424 may access the IPTV system 1400 via the private access network 1466, using information received from the client gateway 1450. In this embodiment, the private access network 1466 may provide security for the private network 1410. User devices may access the client gateway 1450 via the private access network 1466, and the client gateway 1450 may allow such devices to access the private network 1410 once the devices are authenticated or verified. Similarly, the client gateway 1450 may prevent unauthorized devices, such as hacker computers or stolen set-top box devices from accessing the private network 1410, by denying access to these devices beyond the private access network 1466.

For example, when the first representative set-top box device 1416 accesses the system 1400 via the private access network 1466, the client gateway 1450 may verify subscriber information by communicating with the subscriber and system store 1448 via the private network 1410, the first APP switch 1438, and the second APP switch 1440. Further, the client gateway 1450 may verify billing information and status by communicating with the OSS/BSS gateway 1444 via the private network 1410 and the first APP switch 1438. In one embodiment, the OSS/BSS gateway 1444 may transmit a query across the first APP switch 1438, to the second APP switch 1440, and the second APP switch 1440 may communicate the query across the public network 1412 to the OSS/BSS server 1464. After the client gateway 1450 confirms subscriber and/or billing information, the client gateway 1450 may allow the set-top box device 1416 access to IPTV content and VOD content. If the client gateway 1450 is unable to verify subscriber information for the set-top box device 1416, e.g., because it is connected to an unauthorized twisted pair, the client gateway 1450 may block transmissions to and from the set-top box device 1416 beyond the private access network 1466.

As indicated in FIG. 14, the acquisition tier 1406 includes an acquisition tier (AQT) switch 1452 that communicates with the private network 1410. The AQT switch 1452 may also communicate with the operations and management tier 1408 via the public network 1412. In a particular embodiment, the AQT switch 1452 may be coupled to a live acquisition server 1454 that receives television or movie content, for example, from content sources 1456 through an encoder 1455. In a particular embodiment during operation of the IPTV system, the live acquisition server 1454 may acquire television or movie content. The live acquisition server 1454 may transmit the television or movie content to the AQT switch 1452 and the AQT switch 1452 may transmit the television or movie content to the CFT switch 1430 via the private network 1410.

Further, the television or movie content may be transmitted to the video content servers 1480, where it may be encoded, formatted, stored, or otherwise manipulated and prepared for communication to the set-top box devices 1416, 1424. The CFT switch 1430 may communicate the television or movie content to the modems 1414, 1422 via the private access network 1466. The set-top box devices 1416, 1424 may receive the television or movie content via the modems 1414, 1422, and may transmit the television or movie content to the television monitors 1418, 1426. In an illustrative embodiment, video or audio portions of the television or movie content may be streamed to the set-top box devices 1416, 1424.

Further, the AQT switch may be coupled to a video-on-demand importer server 1458 that stores television or movie content received at the acquisition tier 1406 and communicates the stored content to the VOD server 1436 at the client-facing tier 1402 via the private network 1410. Additionally, at the acquisition tier 1406, the VOD importer server 1458 may receive content from one or more VOD sources outside the IPTV system 1400, such as movie studios and programmers of non-live content. The VOD importer server 1458 may transmit the VOD content to the AQT switch 1452, and the AQT switch 1452, in turn, may communicate the material to the CFT switch 1430 via the private network 1410. The VOD content may be stored at one or more servers, such as the VOD server 1436.

When a user issues requests for VOD content via the set-top box devices 1416, 1424, the requests may be transmitted over the private access network 1466 to the VOD server 1436, via the CFT switch 1430. Upon receiving such requests, the VOD server 1436 may retrieve the requested VOD content and transmit the content to the set-top box devices 1416, 1424 across the private access network 1466, via the CFT switch 1430. The set-top box devices 1416, 1424 may transmit the VOD content to the television monitors 1418, 1426. In an illustrative embodiment, video or audio portions of VOD content may be streamed to the set-top box devices 1416, 1424.

FIG. 14 further illustrates that the operations and management tier 1408 may include an operations and management tier (OMT) switch 1460 that conducts communication between the operations and management tier 1408 and the public network 1412. In the embodiment illustrated by FIG. 14, the OMT switch 1460 is coupled to a TV2 server 1462. Additionally, the OMT switch 1460 may be coupled to an OSS/BSS server 1464 and to a simple network management protocol (SNMP) monitor 1478 that monitors network devices within or coupled to the IPTV system 1400. In a particular embodiment, the OMT switch 1460 may communicate with the AQT switch 1452 via the public network 1412.

In an illustrative embodiment, the live acquisition server 1454 may transmit the television or movie content to the AQT switch 1452, and the AQT switch 1452, in turn, may transmit the television or movie content to the OMT switch 1460 via the public network 1412. In this embodiment, the OMT switch 1460 may transmit the television or movie content to the TV2 server 1462 for display to users accessing the user interface at the TV2 server 1462. For example, a user may access the TV2 server 1462 using a personal computer (PC) 1468 coupled to the public network 1412.

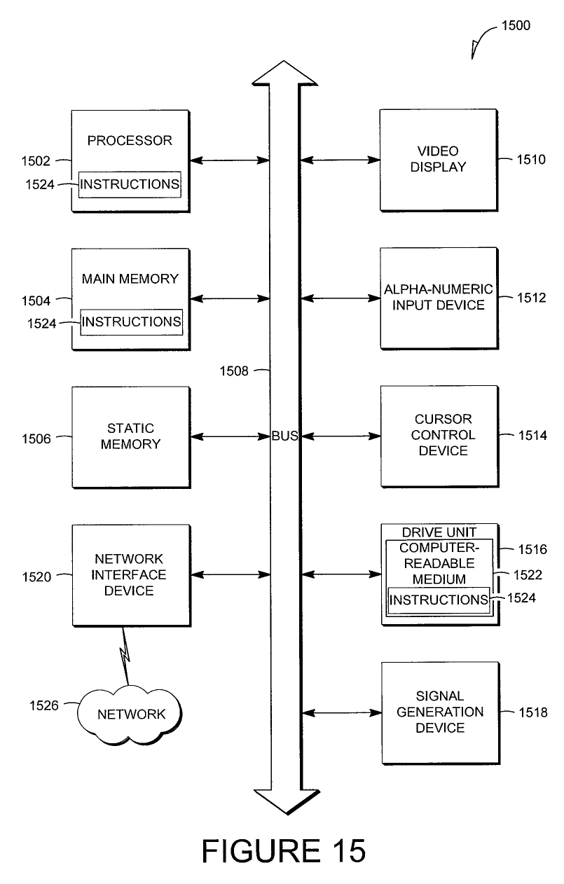

FIG. 15 shows a diagrammatic representation of machine in the example form of a computer system 1500 within which a set of instructions may be executed causing the machine to perform any one or more of the methods, processes, operations, or methodologies discussed herein. The network servers 102, the video sources 210, and/or the database 212 may be deployed on the computer system 1500. The access device 106, the receiver device 202, the display device 204, the residential switch/gateway 206, and/or the provider switch/gateway 208, may include the functionality of the computer system 1500.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a STB, a PDA, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU) a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a cursor control device 1514 (e.g., a mouse), a drive unit 1516, a signal generation device 1518 (e.g., a speaker) and a network interface device 1520.

The drive unit 1516 includes a machine-readable medium 1522 on which is stored one or more sets of instructions (e.g., software 1524) embodying any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

The software 1524 may further be transmitted or received over a network 1526 via the network interface device 1520.

While the machine-readable medium 1522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for content handling have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a client profile, the client profile including a general usage pattern of an access device;
accessing a current usage pattern of the access device, the current usage pattern being based on a plurality of interactions between the access device and a network server during a current time period;
determining whether the current usage pattern is in accordance with the client profile; and
based on the determining, providing a throttle instruction to a networked device to throttle at least one additional interaction of a plurality of additional interactions between the access device and the network server, the networked device being on an access network with the access device and the network server.

2. The method of claim 1, further comprising:
monitoring the plurality of interactions between the access device and the network server during a prior time period to create the general usage pattern.

3. The method of claim 1, further comprising:
adding at least one subscriber attribute to the client profile.

4. The method of claim 1, wherein the accessing of the current usage pattern comprises:
monitoring the plurality of interactions between the access device and the network server during the current time period to identify the current usage pattern.

5. The method of claim 1, further comprising:
determining a plurality of available networked devices on the access network on a network path between the access device and the network server;
selecting the networked device from the plurality of available networked devices in accordance with a selection criterion.

6. The method of claim 1, further comprising:
providing a confirmation instruction to the access device, the access device being capable of receiving the confirmation instruction and providing a confirmation request to a user associated with the access device.

7. The method of claim 1, wherein the determining comprises:
determining whether the current usage pattern is in accordance with the client profile and a physical location correlation, the physical location correlation being based on a physical path of the plurality of interactions between the access device and the network server;
wherein the client profile further includes a physical location correlation.

8. The method of claim 1, wherein the networked device includes at least one of the access device, a residential gateway, a DSLAM, a router, a switch, a network firewall, an application firewall, or combinations thereof.

9. A method comprising:
accessing a programming usage profile, the programming usage profile including a general usage pattern during an identified time period for a program;
monitoring a plurality of interactions between a plurality of access devices and a network server during a current time period associated with the program to identify a current usage pattern.
determining whether the current usage pattern is in accordance with the programming usage profile; and
based on the determining, providing a throttle instruction to at least one networked device to throttle at least one additional interaction of a plurality of additional interactions between the plurality of access devices and the network server, the at least one networked device being on an access network with the plurality of access devices and the network server.

10. The method of claim 9, further comprising:
accessing an override setting for the access network;
wherein the providing of the throttle instruction is in accordance with the override setting.

11. The method of claim 9, wherein the plurality of access devices includes at least one set-top box.

12. The method of claim 8, wherein the network server is an IPTV server.

13. A method comprising:
accessing a client profile, the client profile including a general usage pattern of an access device;
monitoring a plurality of interactions with a network server during a current time period to identify a current usage pattern;
determining whether the current usage pattern is in accordance with the client profile; and
throttling at least one additional interaction of a plurality of additional interactions to the network server.

14. The method of claim 13, further comprising:
providing a confirmation request for presentation; and
receiving a user response to the confirmation request

15. A machine-readable medium comprising instructions, which when implemented by one or more processors perform the following operations:
access a client profile, the client profile including a general usage pattern of an access device;
access a current usage pattern of the access device, current usage pattern being based on a plurality of interactions between the access device and a network server during a current time period;
determine whether the current usage pattern is in accordance with the client profile; and
provide a throttle instruction to a networked device to throttle at least one additional interaction of a plurality of additional interactions between the access device and the network server, the networked device being on an access network with the access device and the network server.

16. The machine-readable medium of claim 15 further comprising instructions, which when implemented by one or more processors perform the following operations:
add at least one subscriber attribute to the client profile.

17. The machine-readable medium of claim 15 further comprising instructions, which when implemented by one or more processors perform the following operations:
monitor the plurality of interactions between the access device and the network server during the current time period to identify the current usage pattern.

18. A system comprising:
a profile access module to access a client profile, the client profile including a general usage pattern of an access device;
a pattern access module to access a current usage pattern of the access device, current usage pattern being based on a plurality of interactions between the access device and a network server during a current time period;
a pattern determination module to determine whether the current usage pattern is in accordance with the client profile; and
a throttle instruction module to provide a throttle instruction to a networked device to throttle at least one additional interaction of a plurality of additional interactions between the access device and the network server, the networked device being on an access network with the access device and the network server.

19. The system of claim 18, further comprising:
an override module to access an override setting for the access network;
wherein the providing of the throttle instruction is in accordance with the override setting.

20. The system of claim 18, further comprising:
an alarm notification module to provide an alarm notification regarding the throttle instruction.

21. The system of claim 18, further comprising:
a device availability module to determine a plurality of available networked devices on the access network on a network path between the access device and the network server; and
a device selection module to select the networked device from the plurality of available networked devices in accordance with a selection criterion.

22. The system of claim 18, wherein the plurality of interactions include at least one of a service request, a request to schedule a DVR recording, a request for video on demand content, a request for data, a channel change request, a group right request, a request for an electronic program guide, a search request, a download request, or combinations thereof.

23. The system of claim 18, wherein the subscriber attribute includes at least one of a client subscription, a logical identifier, a physical identifier, a physical location correlation, or combinations thereof.
